(19) United States
(12) Patent Application Publication
(10) Pub. No.: US 2025/0149792 A1
(43) Pub. Date: May 8, 2025

(54) COMPOSITE STRUCTURAL ANTENNA

(71) Applicant: University of Kansas, Lawrence, KS (US)

(72) Inventors: Emily Arnold, Tonganoxie, KS (US); Ankur Patil, Aberdeen, SD (US)

(21) Appl. No.: 18/835,959

(22) PCT Filed: Feb. 7, 2023
(86) PCT No.: PCT/US2023/062117

§ 371 Date: Aug. 5, 2024

Related U.S. Application Data
(60) Provisional application No. 63/307,774, filed on Feb. 8, 2022.

(51) Int. Cl. H01Q 9/04; B32B 15/14; B32B 15/20; H01Q 1/28

(52) U.S. Cl. CPC H01Q 9/0414; B32B 15/14; B32B 15/20; H01Q 1/287; B32B 2262/106; B32B 2605/18

(57) ABSTRACT

Composite antennas and methods of forming the composite antennas are described. In one example, a composite antenna includes a plurality of strips of carbon fiber material, and a metal shim strip. A portion of the metal shim strip is positioned and embedded between two of the strips of carbon fiber material in a layup stack of the strips of carbon fiber material and the metal shim strip. In another example, a method of forming a composite antenna includes cutting carbon fiber material into a plurality of strips of carbon fiber material, cutting metal shim stock into a metal shim strip, arranging the strips of carbon fiber material, the metal shim strip, and an uncured resin into a layup stack of material, and curing the layup stack of material to form a laminate stack.

### CROSS-REFERENCE TO RELATED APPLICATION

This application claims priority to co-pending U.S. provisional application entitled, “Composite Structural Antenna,” having Ser. No. 63/307,774, filed Feb. 8, 2022, which is entirely incorporated herein by reference.

### GOVERNMENT LICENSE RIGHTS

This invention was made with government support under Grant No. OPP-1848210 awarded by the National Science Foundation. The government has certain rights in the invention.

### TECHNICAL FIELD

The present disclosure is generally related to carbon fiber composite antennas.

### BACKGROUND OF THE INVENTION

An antenna is an interface between radio waves propagating through space and electric currents moving in conductive materials. In transmission, a radio transmitter supplies an electric current, typically at radio frequencies, to electrical contacts or terminals of the antenna. The antenna radiates the energy from the current as electromagnetic waves. In reception, an antenna intercepts some of the power of a radio wave, to produce an electric current at the terminals.

### SUMMARY

Embodiments of the present disclosure provide novel carbon fiber composite antenna systems and related methods of forming a carbon fiber composite antenna. One such method comprises cutting carbon fiber material into a plurality of strips of carbon fiber material; cutting metal shim stock into a metal shim strip; arranging the strips of carbon fiber material, the metal shim strip, and an uncured resin into a layup stack of material, wherein a portion of the metal shim strip is positioned and embedded between two of the strips of carbon fiber material in the layup stack of material; and curing the layup stack of material to form a laminate stack.

An additional method of forming a composite antenna comprises cutting carbon fiber material into a plurality of strips of carbon fiber material; cutting metal shim stock into a metal shim strip; arranging the strips of carbon fiber material, the metal shim strip, and an uncured resin into a layup stack of material, wherein the metal shim strip is positioned on an exterior surface of at least one of the strips of carbon fiber material in the layup stack of material; and/or curing the layup stack of material to form a laminate stack.

Correspondingly, an exemplary carbon fiber composite antenna system comprises a plurality of strips of carbon fiber material; and a metal shim strip, wherein a portion of the metal shim strip is positioned and embedded between two of the strips of carbon fiber material in a layup stack of the strips of carbon fiber material and the metal shim strip.

In one or more aspects, such methods and/or systems comprise before the curing, soldering a conductor from a radio frequency (RF) feed line to the metal shim strip; testing at least one electrical characteristic of the laminate stack; trimming the laminate stack to size based on the testing, to alter at least one electrical characteristic of the laminate stack for use as the composite antenna; before the curing, inserting at least one metal fastener through the strips of carbon fiber material and the metal shim strip; before arranging the metal shim strip with the strips of carbon fiber material, sanding the metal shim strip using sandpaper to provide better structural bonding and electrical connection with the carbon fiber material; the cutting comprises cutting the metal shim stock into a plurality of metal shim strips; and/or the arranging comprises arranging the strips of carbon fiber material, the metal shim strips, and the uncured resin into the layup stack of material, wherein a first metal shim and a second metal shim strip among the metal shim strips and are each positioned and embedded at different locations between two of the strips of carbon fiber material in the layup stack of material.

In one or more aspects of such methods and/or systems, the carbon fiber material comprises a weave of carbon fiber; the metal shim stock comprises copper or aluminum shim stock; the metal shim strip comprises two opposing major surfaces; a first surface among the two opposing major surfaces is entirely in contact with a strip of carbon fiber material in the layup stack of material; and/or a second surface among the two opposing major surfaces is partly in contact with a strip of carbon fiber material in the layup stack of material.

In one or more aspects of such methods and/or systems, the portion of the metal shim strip that is embedded between the strips of carbon fiber material is enclosed by the carbon fiber material; another portion of the metal shim strip is exposed and not enclosed by the carbon fiber material; a second metal shim strip, wherein a portion of the second metal shim strip is positioned and embedded between two of the strips of carbon fiber material in the layup stack; another portion of the metal shim strip is exposed and forms a first contact for the composite antenna; another portion of the second metal shim strip is exposed and forms a second contact for the composite antenna; a radio frequency (RF) feed line soldered to the first contact; an electrically-conductive rigid bracket, the bracket being mechanically and electrically secured to the second contact for extending an electrical length of the composite antenna to a second layup stack; the composite antenna is arranged as a structural, load-bearing member in an assembly of parts; the composite antenna is arranged as a structural, load-bearing member in a Unmanned Aircraft System (UAS); and/or the structural, load-bearing member comprises a wing spar or a longeron.

Other systems, methods, apparatuses, features, and advantages of the present disclosure will be or become apparent to one with skill in the art upon examination of the following drawings and detailed description. It is intended that all such additional systems, methods, features, and advantages be included within this description and be within the scope of the present disclosure.

### BRIEF DESCRIPTION OF THE DRAWINGS

FIG. 1A illustrates a side view of an example carbon fiber reinforced plastic composite antenna formed from a layup stack of material according to various aspects of the embodiments.

FIG. 1B illustrates a top view of the example composite antenna shown in FIG. 1A.

FIGS. 1C-1D illustrate top and side views of example composite dipole antennas having a surface-fed antenna design and a mid-fed antenna design, respectively.

FIG. 2 illustrates a side view of another exemplary composite antenna formed from a layup stack of material according to various aspects of the embodiments.

### DETAILED DESCRIPTION

Potential applications of carbon fiber composite materials for structural antennas are described herein. Carbon fiber composite materials provide relatively high specific strength and stiffness. However, the electrical properties of carbon fiber composite materials, such as electrical conductivity, are not very well established, especially in the very high frequency range. Through the experimental and simulated analysis of a number of carbon fiber composite antennas, the effective conductivity and other electrical parameters or characteristics of the antennas were found to be suitable for several applications, particularly in the very high frequency spectrum.

The performance of prior carbon fiber composite antennas have been found to be relatively poor. Based on the research described herein, the performance of carbon fiber composite antennas is particularly sensitive to the contact between the carbon fibers and the conductive contact feed(s) of the antennas. Using the designs and techniques described herein, the gain and radiation efficiencies of carbon fiber composite antennas were found to be within 0.2 dB and 10%, respectively, of geometrically identical copper antennas, and their bandwidths were found to be nearly identical. Thus, the electrical performance of the carbon fiber composite antennas described herein demonstrate significant promise for a variety of RF applications.

The designs and methods presented herein consider the contact between the carbon fibers and the conductive contact feed(s) of the antennas. Feeding a carbon fiber reinforced plastic (CFRP) antenna can be relatively difficult because soldering to the CFRP material is not possible in the conventional sense. Electrodeposition processes can be used for metalizing the dry carbon, but this effect is negated when mixed with the matrix polymer. In other instances, carbon nanotubes or silver nanoparticles have been added to the resin system to improve overall conductivity of the material. However, these approaches significantly increase cost and do not guarantee an adequate electrical connection between the feed and the antenna. According to aspects of the embodiments, one or more copper strips are embedded on or in layers of carbon fiber material and are co-cured with the resulting laminate.

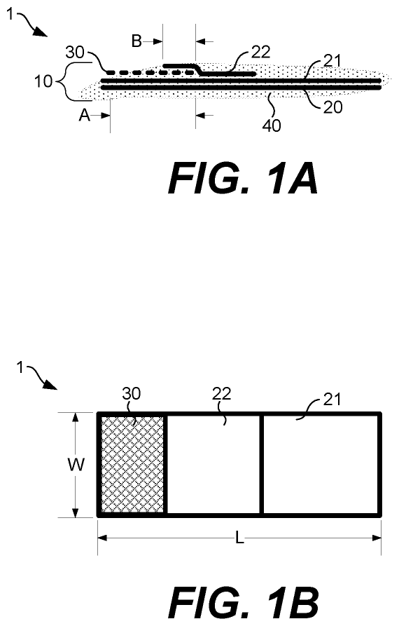

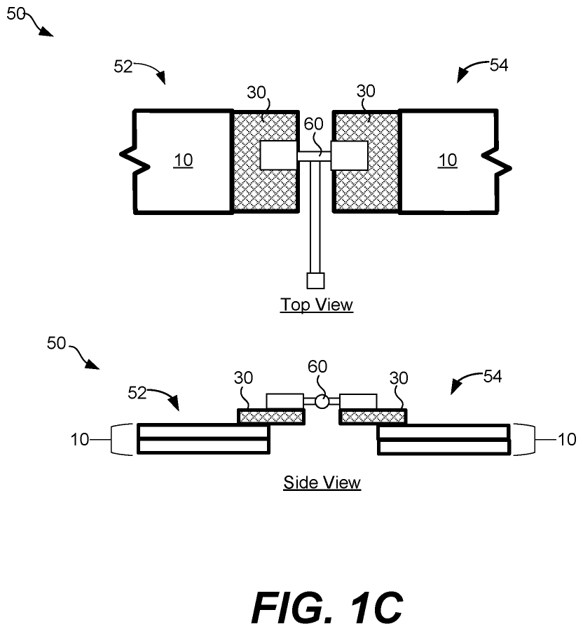

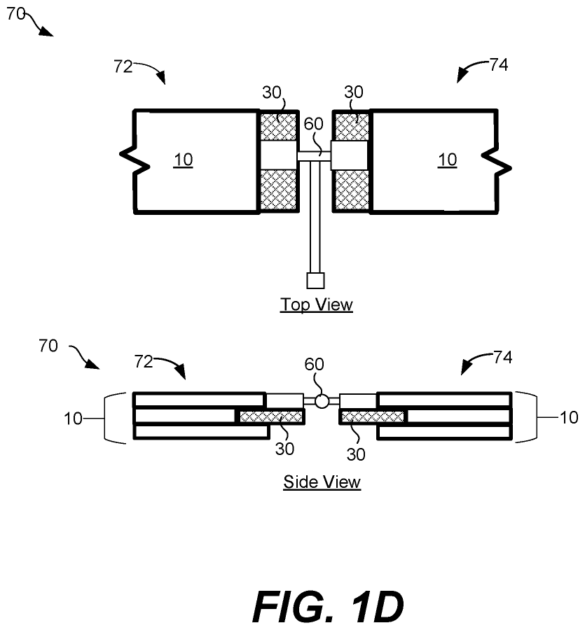

Turning to the Drawings, FIG. 1A illustrates a side view of an example composite antenna 1 formed from a layup stack of material or laminate 10. In general, the layup stack is formed by applying layers of materials to form the composite antenna. FIG. 1B illustrates a top view of the example composite antenna 1 shown in FIG. 1A. The composite antenna 1 and the stack of material 10 are provided as representative examples in FIGS. 1A and 1B. The composite antenna 1 is not necessarily drawn to scale in FIGS. 1A and 1B. For example, the strips of carbon fiber material in the composite antenna 1 can extend further in length to the right, to the left, or both to the right and to the left, as depicted on the page. Additionally, the size, placement, and position of the metal shim strip can vary as compared to that shown. The illustration in FIGS. 1A and 1B are also not exhaustive, and one or more additional layers of material can be included or omitted in some cases.

Referring to FIG. 1A, the stack of material 10 (also “stack 10”) includes a layer or strip of carbon fiber material 20, a layer or strip of carbon fiber material 21, an overlap strip of carbon fiber material 22, a metal shim strip 30, and a resin 40 for binding the stack 10 together. According to the embodiments described herein, the stack 10 can be relied upon as the composite antenna 1. The composite antenna 1 is designed to account for a number of factors, including the overall weight of the composite antenna 1, the structural integrity of the composite antenna 1, the ability for the composite antenna 1 to provide structural support in a larger assembly of parts, and suitable electrical characteristics for the composite antenna 1 to act as an antenna, among possibly others.

The strips of carbon fiber material 20-22 can be embodied by carbon fiber fabric material that has been cut to certain shapes and sizes, such as elongated strips, for example. The carbon fiber fabric material is woven from threads or “tows” of carbon fiber. A tow of carbon fiber can be characterized by the number of carbon fiber filaments in the tow fiber, commonly referenced as 3K, 6K, 12K, 15K, or 24K, as examples. A 3K tow of carbon fiber is composed of 3,000 individual carbon filaments. Because a single strand of carbon fiber is only about 5-10 microns thick, a 3K tow of carbon fiber is still relatively thin, at around 0.006-0.0125 inches thick. To create a carbon fiber fabric material, spools of carbon fiber tows are woven into fabrics, using a weaving loom or other technique. Common weaves include plain weave, twill weave, and harness satin weave, although other weaves are known, and tape carbon fiber fabric material is also known and can be used. In some cases, the carbon fiber fabric material can be pre-impregnated with the resin 40, and the resin 40 can be cured by heating, but the resin 40 is typically added separately as described below.

The metal shim strip 30 can be embodied as a thin strip of highly conductive metal, such as copper, that has been cut to a certain shape and size. In one example, the metal shim strip 30 can be cut from metal shim stock having a thickness of between 0.015-0.018 inches, although other thicknesses can be relied upon. Additionally, the metal shim strip 30 can be embodied as other types of metals, such as gold, silver, aluminum, and others. In some cases, the metal shim strip 30 can be embodied as other types of conductive materials, such as thin semiconductor materials that have been doped for conductivity. As described herein, an exposed outer surface of the metal shim strip 30 can be relied upon as an electrical contact or terminal of the composite antenna 1. The terminal can be electrically coupled to a transmitter for transmission, coupled to a receiver for reception, or coupled to another segment or section of a similar composite antenna.

The resin 40 can be embodied as a polyepoxide and, more particularly, as a thermosetting polymer. In one example, the resin 40 can be embodied as an epoxy resin, and the resin 40 acts as a binding polymer among the layers in the stack 10. The resin 40 can be embodied as other thermoset or thermoplastic polymers, however, that are suitable as binders in the stack 10. The resin 40 can be incorporated in the stack 10 as part of a wet layup, as described herein, and cured, similar to the way that carbon fiber reinforced plastics are formed. The composite antenna 1 can also be formed to have a certain shape in a mold or other form, before the resin 40 cures, and the composite antenna 1 can assume the form or shape in a rigid embodiment, after the resin 40 has cured.

Referring to FIG. 1B, the dimensions of the composite antenna 1, including the length “L” and the width “W,” can vary among the embodiments. The dimensions of the metal shim strip 30 can also vary among the embodiments. The overall size of the metal shim strip 30 can be selected to balance the need for good electrical contact and electrical characteristics of the composite antenna 1, while at the same time avoiding unnecessary weight of the composite antenna 1. As shown in FIGS. 1A and 1B, the length “A” of the metal shim strip 30 is less than the total length of the composite antenna 1, and the width of the metal shim strip 30 is the same as the width “W” of the composite antenna 1, although the width can vary. The strip of carbon fiber material 22 is placed to overlap the metal shim strip 30 by the dimension “B.” This increased physical contact between the metal shim strip 30 and the carbon fiber layers results in improved performance of the composite antenna 1. The dimension “B” can range from about 0.25 to 1.5 inches in some cases. In one preferred embodiment, the dimension “B” can be about 0.5 inches. The ratio of “A” to “B” can range from 1.2 to 1.8, for example, although other ranges can be used. In one preferred case, the ratio of “A” to “B” is about 1.5. Since the performance of the composite antenna 1 is affected by the amount of overlap between the metal shim strip 30 and the strip of carbon fiber material 21 and 22, the overall size of the metal shim strip 30 can be varied to achieve a desired quality of electrical contact and electrical characteristics of the composite antenna 1.

The overall thickness of the composite antenna 1, as measured from the top to the bottom of the page in FIG. 1A, can also vary depending on a number of factors, including the thickness of the carbon fiber fabric material used, the number of layers of carbon fiber material used, the thickness of the metal shim stock, and other factors. The composite antenna 1 can be tailored for strength, size, and other parameters by varying the type and number of layers of carbon fiber fabric, to meet the requirements of many different applications. In some cases, the final size of the composite antenna 1 can be determined by cutting or shearing the composite antenna 1 to shape, as described herein.

The composite antenna 1 has been shown to exhibit better electrical properties as compared to other composite antennas. Testing has shown that the performance is due, at least in part, to the arrangement of the layers in the composite antenna 1 and the manner in which the composite antenna 1 is manufactured or formed. In other cases, composite antennas according to the embodiments can include additional layers or strips of carbon fiber material, additional metal shim strips or contacts positioned at other sides and at other locations, and other variations.

As a non-limiting example, FIG. 1C shows top and side views of a surface-fed composite dipole antenna 50 having the metal shim strip 30 feeding into the layup stack of carbon fiber and resin material or laminate 10 at a surface layer of each dipole arm 52, 54, such that a feeding cable 60 can be soldered to the composite dipole antenna 50 at an exposed surface of the metal shim strip 30 at each dipole arm 52, 54. In various embodiments, a various number of layers of carbon fiber materials (e.g., one or more carbon material layers) can be deployed. Correspondingly, FIG. 1D shows top and side views of a mid-fed composite dipole antenna 70 having the metal shim strip 30 feeding into the layup stack of carbon fiber and resin material or laminate 10 at a middle layer (e.g. non-surface layer) of each dipole arm 72, 74, such that a feeding cable 60 can be soldered to the composite dipole antenna at an exposed surface of the metal shim strip 30 at each dipole arm 72, 74. In various embodiments, a various number of layers of carbon fiber materials (e.g., two or more carbon material layers) can be deployed.

The composite antenna 1 can be formed in a number of steps in a process or method for forming a composite antenna. The process can include cutting carbon fiber material into a plurality of strips of carbon fiber material. For example, the strips of carbon fiber material 20-22 can be cut from a larger sheet of carbon fiber material, to any suitable size. The process can also include cutting metal shim stock into a metal shim strip. For example, the metal shim strip 30 can be cut from a larger sheet of metal shim stock.

The process can also include arranging the strips of carbon fiber material, the metal shim strip, and an uncured resin into a layup stack of material. For example, the layers of material 20-22 and 30 can be arranged with the resin 40, to arrive at the stack of material 10 shown in FIGS. 1A and 1B, using a wet layup technique. In this arrangement, the resin 40 can be spread above, below, and between the layers of material 20-22, in a layering process. The metal shim strip 30 can also be placed on or over the strip of carbon fiber material 21, after the resin 40 has been thinly spread over the strip of carbon fiber material 21. The strip of carbon fiber material 22 can then be placed to overlap the metal shim strip 30 and the strip of carbon fiber material 21. In some cases, the strip of carbon fiber material 22 can be embodied as two or more separated strips of carbon fiber material, including one placed side-by-side with the metal shim strip 30 and another overlapping the side-by-side layer and the metal shim strip 30. Once the stack of material 10 is arranged, the process can also include curing the stack of material 10 to form a laminate stack.

The stack of material 10 can be cured in various ways. The stack of material 10 can be formed into certain shapes while curing. For example, the stack of material 10 can be layered into a mold having a certain shape, such as a “C” shape, an “I” shape, a “V” shape, a circular shape, a triangular shape, a rectangular or square shape, or another shape. The mold and stack of material 10 can then be heated or air-cured. In some cases, the mold and stack of material 10 can be vacuum-bagged and/or autoclave-cured, to help avoid air bubbles in the laminate stack. In another example, the stack of material 10 can be arranged over a flat aluminum mold, which is polished and waxed, and has a release agent applied to it. A vacuum seal or bag can then be placed over the stack of material 10, and a vacuum can be applied to cure and avoid air bubbles in the laminate stack. While the vacuum is applied, a roller can also be applied to squeeze air bubbles out in some cases. Particularly for unidirectional carbon fiber tape laminates that include a larger number of layers (e.g., 4-12 layers laminate), air bubbles between the laminate and the mold might not break or move under vacuum pressure. A manual roller can be used in these cases to help push these air bubbles out.

In some cases, rather than using the typical wet layup technique, the stack of material 10 can be arranged in a mold, and the resin 40 can be added using an infusion technique where the resin 40 is drawn through the stack of material 10 using a vacuum. In this case, the vacuum pulls the resin 40 through a tube and into the vacuum seal or bag. The resin 40 can be dispersed or spread over the stack of material 10 within the bag. In another technique, the layers of material 20-22 are already impregnated with the resin 40. In this case, the stack of material 10 can be arranged in a mold, and the mold and stack of material 10 can be placed in a vacuum to cure. In still another technique, a compression mold can be relied upon, possibly with the application of heat.

After the stack of material 10 is cured into the laminate stack, electrical contact with the composite antenna 1 can be achieved by soldering an RF feed line to the exposed surface of the metal shim strip 30. The process for forming a composite antenna 1 can also include testing at least one electrical characteristic of the laminate stack. Among others, any of the electrical characteristics, such as the S-parameters of the composite antenna 1, can be measured or tested. The process can also include trimming or cutting the laminate stack based on the testing to alter the electrical characteristic(s) of the laminate stack.

An electrical RF feed connection can be made to the metal shim strip 30 before the stack of material 10 is arranged together and cured in some cases. Soldering a conductor to the metal shim strip 30 before curing permits the metal strip 30 to be covered more completely between the strips of carbon fiber material 20-22. It can also protect the soldering connection and metal shim strip 30 from physical harm and environmental effects, further improve electrical performance and structural strength, and avoid debonding by heating after curing.

In some cases, the connection between the metal shim strip 30 and the strips of carbon fiber material 20-22 can be mechanically augmented. For example, one or more metal vias, pins, posts, crimps, or other mechanical fasteners can be inserted through the metal shim strip 30 and the strips of carbon fiber material 20-22, to further bind and hold them together, before the stack of material 10 is cured. The fasteners can be positioned around the periphery of the metal shim strip 30, for example, as well as toward the center of the metal shim strip 30 in some cases. The fasteners can be soldered to the metal shim strip 30 in some cases. In one example, the fasteners can be embodied as pins with heads at one end. The pins can be inserted through the back side of the strip of carbon fiber material 20, through the strips of carbon fiber material 20-22 and the metal shim strip 30, and the fasteners can be cut to size and soldered in place to the exterior-facing surface of the metal shim strip 30. In other examples, one or more push-in-wire connectors can be secured to the metal shim strip 30 before the stack of material 10 is cured.

Two of the composite antenna 1 can be formed separately, and the pair can be used together as a dipole antenna. For example, the inner center conductor of a coaxial cable can be soldered onto the exposed portion of the metal shim strip 30 of a first composite antenna 1. The braided outer conductor of the coaxial cable can be soldered onto the metal shim strip 30 of a second composite antenna 1. An RF connector (e.g., SubMiniature or other type) can be used as a feed point at another end of the coaxial cable, and the two composite antennas with cable can be relied upon as a dipole antenna. A coaxial cable along with Balun, for example, can be used to balance an unbalanced antenna system.

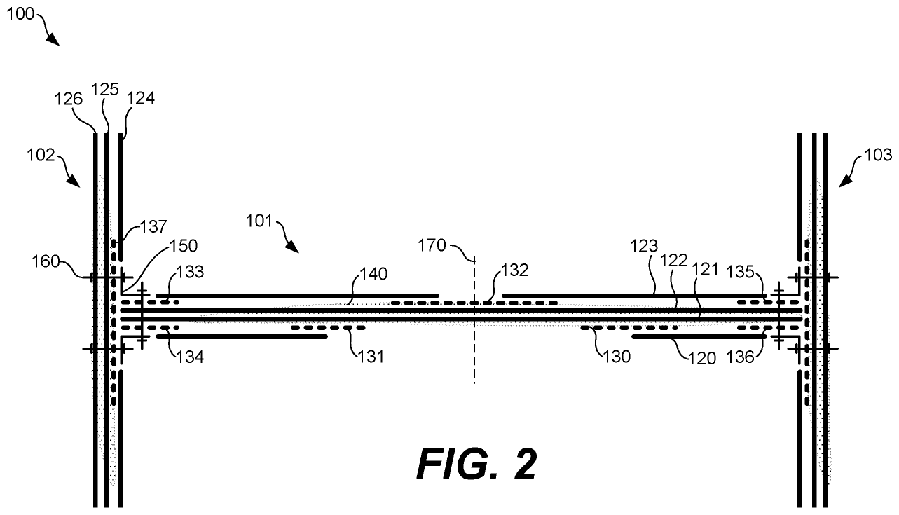

FIG. 2 illustrates a side view of another example composite antenna 100. The composite antenna 100 is provided as a representative example in FIG. 2. The composite antenna 100 is not necessarily drawn to scale in FIG. 2. The illustration in FIG. 2 is also not exhaustive, and one or more additional layers of material can be included or omitted in some cases.

The composite antenna 100 includes a stack of material 101, a stack of material 102, and a stack of material 103. Among possibly other layers, the stack of material 101 includes layers or strips of carbon fiber material 120-123, metal shim strips 130-136, and a resin 140 for binding the stack 101 together. The stack of material 102 includes layers or strips of carbon fiber material 124-126, a metal shim strip 137, and the resin 140 for binding the stack 102 together. The stack of material 103 is similar to the stack of material 102.

The relative sizes, shapes, and positions of the stacks of material 101-103 can vary as compared to that shown in FIG. 2. For example, the stacks of material 102 and 103 can each be formed into shapes other than the straight segment shown, such as into a “C” shape. In another example, the stack of material 101 can be formed, either alone or with other laminate stacks, into an “I” shape.

According to the embodiments described herein, the composite antenna 100 can take various forms, and the composite antenna 100 can be relied upon as a structural, load-bearing support member of a larger assembly, such as wing spar, longeron member of the fuselage, or the landing gear of an Unmanned Aircraft System (UAS). The antennas described herein can be relied upon as an aircraft spars, wing components, wing skins, control surfaces, tail booms, and other aircraft components to form multifunctional load-bearing antenna structures. The antennas can also be relied upon in space applications, as lightweight CFRP structures that hold payloads during rocket launch and after payload delivery, and then unfold or extend to form radiating antenna structures. The antennas can also be relied upon in automotive applications, in which an automotive CFRP antenna structure is integrated into the automobile body.

In the composite antenna 100, the strips of carbon fiber material 120-126 and the metal shim strips 130-137 are similar to the strips of carbon fiber material 20-22 and the metal shim strip 30 shown in FIGS. 1A and 1B, respectively. The stacks of material 101-103 are cured into laminate stacks, with the resin 140 being cured to bind them together. The composite antenna 100 can also be assembled in a way that is similar to that described above with reference to FIGS. 1A and 1B, although the step of arranging the stacks of material 101-103 is different.

The composite antenna 100 also includes a number of brackets, such as the bracket 150, among others. The bracket 150 can be embodied as an electrically-conductive rigid bracket. The bracket 150 can be formed from copper or another metal or conductor. As shown in FIG. 2, the bracket 150 is formed as an “L”-shaped bracket. The bracket 150 is used to secure the stack of material 102 at one distal end of the stack of material 101 in the composite antenna 100, with the stack of material 102 extending perpendicular to the stack of material 101. Similar brackets can be used to secure the stack of material 103 at another distal end of the stack of material 101, with the stack of material 103 extending perpendicular to the stack of material 101. Fasteners, such as the fastener 160, can be used to secure the bracket 150, among others, between the stacks of material 101 and 102. The fasteners can be any suitable fastener, such as screws and bolts, pins, posts, crimps, or other mechanical fasteners. In some cases, one or both of the bracket 150 and the fastener 160 can be soldered to the metal shim strips 133 and 137, and other brackets can be secured and/or soldered in a similar way.

The exposed outer surfaces of each of the metal shim strips 130-137 in the composite antenna 100, among others, can act as terminals or conductive interconnects. The exposed outer surfaces can be relied upon for electrical coupling to RF feeds and/or for interconnects among the stacks of material 101-103. The composite antenna 100 can also be embodied as a dipole antenna, by cutting it along the line 170 shown in FIG. 2. In that case, RF feeds can be soldered respectively to the metal shim strip 131 and the metal shim strip 130, as one example. Additional passive components and/or networks of passive components can be electrically coupled with the composite antenna 100. Such components can be coupled between the separated sections of the shim strip 132, for example, after it has been cut.

The composite antenna 100 is designed to account for a number of factors, including the overall weight of the composite antenna 100, the structural integrity of the composite antenna 100, the ability for the composite antenna 100 to provide structural support in a larger assembly of parts, and suitable electrical characteristics for the composite antenna 100 to act as an antenna, among possibly others.

It should be emphasized that the above-described embodiments of the present disclosure are merely possible examples of implementations, merely set forth for a clear understanding of the principles of the disclosure. Many variations and modifications may be made to the above-described embodiment(s) without departing substantially from the principles of the present disclosure. All such modifications and variations are intended to be included herein within the scope of this disclosure and protected by the following claims.

1. A method of forming a composite antenna, comprising:
cutting carbon fiber material into a plurality of strips of carbon fiber material;
cutting metal shim stock into a metal shim strip;
arranging the strips of carbon fiber material, the metal shim strip, and an uncured resin into a layup stack of material, wherein a portion of the metal shim strip is positioned and embedded between two of the strips of carbon fiber material in the layup stack of material; and
curing the layup stack of material to form a laminate stack.

2. The method of claim 1, further comprising:
before the curing, soldering a conductor from a radio frequency (RF) feed line to the metal shim strip.

3. The method of claim 1, further comprising:
testing at least one electrical characteristic of the laminate stack; and
trimming the laminate stack to size based on the testing, to alter at least one electrical characteristic of the laminate stack for use as the composite antenna.

4. The method of claim 1, further comprising:
before the curing, inserting at least one metal fastener through the strips of carbon fiber material and the metal shim strip.

5. The method of claim 1, further comprising:
before arranging the metal shim strip with the strips of carbon fiber material, sanding the metal shim strip using sandpaper to provide better structural bonding and electrical connection with the carbon fiber material.

6. The method of claim 1, wherein the carbon fiber material comprises a weave of carbon fiber.

7. The method of claim 1, wherein the metal shim stock comprises copper or aluminum shim stock.

8. The method of claim 1, wherein:
the metal shim strip comprises two opposing major surfaces;
a first surface among the two opposing major surfaces is entirely in contact with a strip of carbon fiber material in the layup stack of material; and
a second surface among the two opposing major surfaces is partly in contact with a strip of carbon fiber material in the layup stack of material.

9. The method of claim 1, wherein:
the cutting comprises cutting the metal shim stock into a plurality of metal shim strips; and
the arranging comprises arranging the strips of carbon fiber material, the metal shim strips, and the uncured resin into the layup stack of material, wherein a first metal shim and a second metal shim strip among the metal shim strips and are each positioned and embedded at different locations between two of the strips of carbon fiber material in the layup stack of material.

10. A composite antenna, comprising:
a plurality of strips of carbon fiber material; and
a metal shim strip, wherein a portion of the metal shim strip is positioned and embedded between two of the strips of carbon fiber material in a layup stack of the strips of carbon fiber material and the metal shim strip.

11. The composite antenna of claim 10, wherein:
the portion of the metal shim strip that is embedded between the strips of carbon fiber material is enclosed by the carbon fiber material; and
another portion of the metal shim strip is exposed and not enclosed by the carbon fiber material.

12. The composite antenna of claim 10, further comprising:
a second metal shim strip, wherein a portion of the second metal shim strip is positioned and embedded between two of the strips of carbon fiber material in the layup stack.

13. The composite antenna of claim 12, wherein:
another portion of the metal shim strip is exposed and forms a first contact for the composite antenna; and
another portion of the second metal shim strip is exposed and forms a second contact for the composite antenna.

14. The composite antenna of claim 13, further comprising:
a radio frequency (RF) feed line soldered to the first contact; and
an electrically-conductive rigid bracket, the bracket being mechanically and electrically secured to the second contact for extending an electrical length of the composite antenna to a second layup stack.

15. The composite antenna of claim 10, arranged as a structural, load-bearing member in an assembly of parts.

16. The composite antenna of claim 10, arranged as a structural, load-bearing member in a Unmanned Aircraft System (UAS).

17. The composite antenna of claim 16, wherein the structural, load-bearing member comprises a wing spar or a longeron.

18. A method of forming a composite antenna, comprising:
cutting carbon fiber material into a plurality of strips of carbon fiber material;
cutting metal shim stock into a metal shim strip;
arranging the strips of carbon fiber material, the metal shim strip, and an uncured resin into a layup stack of material, wherein the metal shim strip is positioned on an exterior surface of at least one of the strips of carbon fiber material in the layup stack of material; and
curing the layup stack of material to form a laminate stack.
